(19) United States
(12) Patent Application Publication
(10) Pub. No.: US 2022/0347577 A1
(43) Pub. Date: Nov. 3, 2022

(54) GAMING SYSTEM AND METHOD HAVING PLAYER DEFINED GAMES

(71) Applicant: I WIN GAMES, LLC, Saint Louis, MO (US)

(72) Inventor: Terrance Wright, Maryville, IL (US)

(21) Appl. No.: 17/729,324

(22) Filed: Apr. 26, 2022

Related U.S. Application Data
(60) Provisional application No. 63/180,709, filed on Apr. 28, 2021.

(51) Int. Cl. A63F 13/63

(52) U.S. Cl. CPC A63F 13/63

(57) ABSTRACT

Various game systems and methods enable players to create one or more player defined games. At least a portion of the player defined games may be played in one or more secondary games. The player defined games may include one or more remotely located players. The game systems and methods may use an improved data communication process with one or more secondary game servers to obtain data related to one or more secondary games more efficiently. In some implementations, the improved data communication process enables more efficient evaluation of one or more player defined games.

### CROSS REFERENCE TO RELATED APPLICATIONS

This application claims priority to U.S. Provisional Application Ser. No. 63/180,709 filed on Apr. 28, 2021, whose entire disclosure is hereby incorporated by reference.

### TECHNICAL FIELD

This disclosure relates to a gaming system and method. More specifically, this disclosure relates to a gaming system and method having player defined games for players playing a single player or multiplayer online video game.

### BACKGROUND

Online video games are popular. Some online video games enable multiple players to play an online video game with each other over a network. Some prominent examples of multiplayer online video games include, but are not limited to, fighting games, sports games, and strategy games. To retain players' interest in online video games, gaming systems that offer new and unconventional functionality are needed.

### SUMMARY

Various game systems and methods include enabling players to create one or more player defined games. At least a portion of the player defined games may be played in one or more secondary games. The player defined games may include one or more remotely located players. The game systems and methods may use an improved data communication process with one or more secondary game servers to obtain data related to one or more secondary games more efficiently for the player defined games. In some implementations, the improved data communication process enables more efficient evaluation of one or more player defined games. In some implementations, the player defined games can be challenges defined by one or more players.

In some aspects, the techniques described herein relate to a game system including: a memory device, and a processor, wherein the memory device stores program instructions that, when executed by the processor, cause the processor to: receive a request to create a player defined game; receive a selection of a secondary game; generate one or more configuration options for the player defined game based on the selection of the secondary game; receive one or more selected configuration options for the player defined game; receive a unique identifier for a player that will participate in the player defined game; execute the player defined game; analyze a plurality of different player defined games, wherein the plurality of different player defined games includes the player defined game; determine minimally sufficient player data from the plurality of different player defined games to obtain secondary game data for the plurality of different player defined games; transmit a request to a remote server for the secondary game data for the plurality of different player defined games based on the minimally sufficient player data; receive the secondary game data for the plurality of different player defined games from the remote server; associate a portion of the secondary game data with the player defined game; determine an outcome of the player defined game based in part on the portion of secondary game data.

In some aspects, the techniques described herein relate to a system, wherein determining minimally sufficient player data from the plurality of different player defined games to obtain secondary game data for the plurality of different player defined games further includes: de-aggregation of at least one type of data from plurality of different player defined games.

In some aspects, the techniques described herein relate to a system, wherein the program instructions further cause the processor to: reaggregate at least a portion of the secondary game data to the plurality of the different player defined games; and store the reaggregated at least a portion of the secondary game data in association with the plurality of the different player defined games.

In some aspects, the techniques described herein relate to a system, wherein at least some of the secondary game data associated with at least one of the plurality of the different player defined games is discarded.

In some aspects, the techniques described herein relate to a system, wherein the program instructions further cause the processor to: delete one or more portions of prior reaggregated data based on the storing of the reaggregated at least a portion of the secondary game data.

In some aspects, the techniques described herein relate to a system, wherein the secondary game data includes data from one or more secondary games.

In some aspects, the techniques described herein relate to a system, wherein the data from one or more secondary games further includes different rounds of a same secondary game.

In some aspects, the techniques described herein relate to a system, wherein the data from one or more secondary games includes at least one round of at least two different secondary games.

In some aspects, the techniques described herein relate to a system, wherein the secondary game is a multiplayer game.

In some aspects, the techniques described herein relate to a system, wherein the secondary game is a single player game.

In some aspects, the techniques described herein relate to a system, wherein the program instructions further cause the processor to: transmit an alert of the outcome to at least the first player of the player defined game.

In some aspects, the techniques described herein relate to a system, wherein the program instructions further cause the processor to: receive a plurality of unique identifiers for different players that will participate in the player defined game, wherein at least one of the plurality of unique identifiers for the different players includes a unique identifier for associated with a benchmark player, wherein secondary game data associated with the benchmark player is used in determining the outcome of the player defined game and the benchmark player does not accept participation in the player defined game.

In some aspects, the techniques described herein relate to a method of operating a player defined game system including: receiving, using a processor, a request to create a player defined game; receiving, using the processor, a selection of a secondary game; generating, using the processor, one or more configuration options for the player defined game based on the selection of the secondary game; receiving, using the processor, one or more selected configuration options for the player defined game; receiving, using the processor, a unique identifier for a player that will participate in the player defined game; executing, using the processor, the player defined game; analyzing, using the processor, a plurality of different player defined games, wherein the plurality of different player defined games includes the player defined game; determining, using the processor, minimally sufficient player data from the plurality of different player defined games to obtain secondary game data for the plurality of different player defined games; transmitting, using the processor, a request to a remote server for the secondary game data for the plurality of different player defined games based on the minimally sufficient player data; receiving, using the processor, the secondary game data for the plurality of different player defined games from the remote server; associating, using the processor, a portion of the secondary game data with the player defined game; determining, using the processor, an outcome of the player defined game based in part on the portion of secondary game data.

In some aspects, the techniques described herein relate to a method, wherein determining the minimally sufficient player data from the plurality of different player defined games to obtain secondary game data for the plurality of different player defined games further includes: de-aggregation of at least one type of data from plurality of different player defined games.

In some aspects, the techniques described herein relate to a method, further including: reaggregating at least a portion of the secondary game data in association with the plurality of the different player defined games; and storing the reaggregated at least a portion of the secondary game data in association with the plurality of the different player defined games.

In some aspects, the techniques described herein relate to a method, wherein the secondary game data includes data from one or more secondary games.

In some aspects, the techniques described herein relate to a method, wherein the secondary game data from the one or more secondary games further includes different rounds of a same secondary game.

In some aspects, the techniques described herein relate to a method, wherein the secondary game data from the one or more secondary games includes at least one round of at least two different secondary games.

In some aspects, the techniques described herein relate to a method, wherein the secondary game is a multiplayer game.

In some aspects, the techniques described herein relate to a method, wherein the secondary game is a single player game.

In some aspects, the techniques described herein relate to a method, further including: receiving a plurality of unique identifiers for different players that will participate in the player defined game, wherein at least one of the plurality of unique identifiers for the different players includes a unique identifier for associated with a benchmark player, wherein secondary game data associated with the benchmark player is used in determining the outcome of the player defined game and the benchmark player does not accept participation in the player defined game.

In some aspects, the techniques described herein relate to a system including: one or more memory devices storing programing instructions; and one or more processors configured to execute the program instructions to cause the system to perform operations including: receiving selections for a plurality of player defined games for one or more players playing a secondary online game; determining the one or more players participating in the plurality of player defined games; receiving data, from a remote secondary game system, for the one or more players participating in the player defined game; assigning and duplicating, at least some of the received data for the one or more players for the one or more player defined games; and determining results of at least one of the plurality of player defined games.

In some aspects, the techniques described herein relate to a system, wherein the plurality of player defined games set up are based on one or more options received from one of the players.

In some aspects, the techniques described herein relate to a system, wherein the one or more players include at least two players that are active players.

In some aspects, the techniques described herein relate to a system, wherein the one or more players include at least one benchmark player that does not actively participate in at least one of the plurality of player defined games which includes the benchmark player.

In some aspects, the techniques described herein relate to a system, wherein the one or more processors are further configured to execute the program instructions to cause the system to set up a new player defined game after the plurality of player defined games have started but before the results of all of the plurality of player defined games have been determined.

In some aspects, the techniques described herein relate to a system, wherein the plurality of player defined games includes a first player defined game and a second player defined game, wherein the first player defined game includes players different than the players included in the second player defined game.

In some aspects, the techniques described herein relate to a system including: one or more memory devices storing programing instructions; and one or more processors configured to execute the program instructions to cause the system to perform operations including: setting up one or more player defined games for one or more players playing a multiplayer online game; determining the one or more players participating in the one or more player defined games; receiving data for the one or more players participating in the one or more player defined games; assigning, and duplicating as necessary, the pulled data for the participating player as the data for the participating players for the one or more player defined games; and determining results of one of the player defined games.

In some aspects, the techniques described herein relate to a system including: one or more memory devices storing programing instructions; and one or more processors configured to execute the program instructions to cause the system to perform operations including: setting up one or more player defined games for one or more players playing a multiplayer online game; determining the players participating in the one or more player defined games; receiving pushed data for the players participating in the one or more player defined games; assigning, and duplicating as necessary, the pushed data for the participating player as the data for the participating players for the one or more player defined games; and determining results of one of the player defined games.

It is to be understood that this summary is not an extensive overview of the disclosure. This summary is exemplary and not restrictive. This summary is intended neither to identify key or critical elements of the disclosure nor delineate the scope thereof. The sole purpose of this summary is to explain and exemplify concepts of the disclosure as an introduction to the following complete and extensive detailed description.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

FIG. 1 is one implementation of a schematic of an environment of a gaming system enabling player defined games.

FIGS. 2A, 2B and 2C illustrate one implementation of a method for setting up a player defined game.

FIG. 3 illustrates one implementation of a method for de-aggregation and reaggregation of player data for efficient communication with secondary game systems.

FIG. 4 illustrates one implementation of a method for match analysis of pending player defined games.

FIG. 5 illustrates examples of player defined game attributes that can be game options selected by the user or predefined in an option selected by the user.

FIGS. 6A and 6B illustrate one implementation of a method for de-aggregation of player data in pending player defined games and an implementation method for reaggregation of obtained player data at two different time periods.

### DETAILED DESCRIPTION

The following description is provided as an enabling disclosure of the systems herein, and/or methods in its currently known implementations. To this end, those skilled in the relevant art will recognize and appreciate that many changes can be made to the various implementations of the systems discussed herein, and/or methods described herein, while still obtaining the beneficial results of the disclosure. It will also be apparent that some of the desired benefits of the disclosure can be obtained by selecting some of the features of the disclosure without utilizing other features. Accordingly, those who work in the art will recognize that many modifications and adaptations to the disclosure are possible and can even be desirable in certain circumstances and are a part of the disclosure. Thus, the following description is provided as illustrative of the principles of the disclosure and not in limitation thereof.

As used throughout, the singular forms “a,” “an” and “the” include plural referents unless the context clearly dictates otherwise. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain implementations include, while other implementations do not include, certain features, elements and/or steps. Thus, such conditional language is not generally intended to imply that features, elements and/or steps are in any way required for one or more particular implementations or that one or more particular implementations necessarily include logic for deciding, with or without user input or prompting, whether these features, elements and/or steps are included or are to be performed in any particular implementation.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all implementations of this application including, but not limited to, steps in disclosed methods. Thus, if there are a variety of additional steps that can be performed it is understood that each of these additional steps can be performed with any specific implementation or combination of implementations of the disclosed methods.

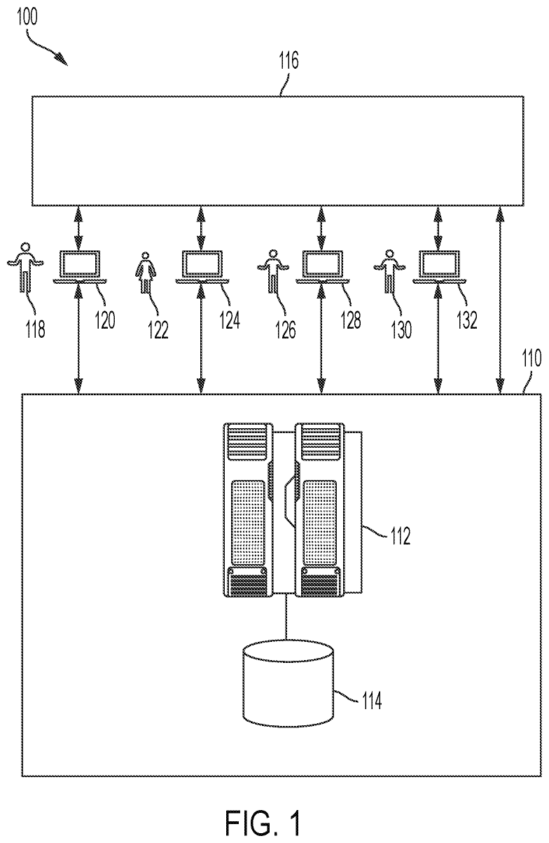

FIG. 1 illustrates an environment 100 of one implementation of a gaming system 110 that enables player defined games that can be played with one or more players. In some implementations, the one or more players can be remote from one or more other players. In some implementations, the player defined games are based at least partially on events that occurs in secondary games. The secondary games may be hosted on servers that are remote and separate from the servers that host the player defined games. The one or more players that access the player defined games can also access the secondary games. At least a portion of the outcome of the player defined games can be evaluated based on data retrieved from the separate servers for the secondary games. In some implementations, a player defined game is referred to as a challenge.

In one implementation, the gaming system 110 is accessible by a player 118, who connects with or is a subscriber to a gaming service associated with the gaming system 110 and is participating in at least one player defined game, through two-way communications with the player's computer 120 or remote terminal 120. The computer 120 and the gaming system 110 may communicate with via a network such as the Internet. The gaming system 110 may be accessible by other players 122 and 126. The other players 122 and 126 may connect with or subscribe to the gaming services associated with the gaming system 110 through two-way communication with the player's computer 124 and 128. The players' computers 120, 124 and 128 may include an output component, such as a monitor, capable of displaying content from the gaming system 110 and may include at least one input component, such as a keyboard, mouse, or touch screen, capable of sending requests and inputs to the gaming system 110. It should be appreciated that while a limited number of players and computers are shown in FIG. 1, any suitable number of players and computers can communicate with the gaming system 110. For example, gaming system 110 may be in communication with thousands or millions of players and computers to enable any suitable number of player defined games or challenges.

FIG. 1 further illustrates an online gaming system 116 (also referred to herein as a secondary game or a secondary game system) accessible by the players 118, 122, and 126 through two-way communications with the players' computers 120, 124 and 128. The secondary game system may enable players to participate in games of any suitable nature (e.g., multiplayer games such as League of Legends™ or DOTA 2™ or single player games such as Forza™ or Asteroids™). In some implementations, secondary game data such as, but not limited to, activities that occurred in during secondary games, results, and/or outcomes of the secondary games played on the secondary game systems are stored by the secondary game systems. In some implementations, the secondary game systems may make such secondary game data available on websites or otherwise accessible. In addition to the players who are participating in at least one player defined game, the multiplayer online gaming system 116 may also be accessible by one or more players 130, who are not participating in any of the player defined games. In some implementations, even though the one or more players 130 are not in communication with the gaming system 110, the gaming system 110 may nevertheless enable the one or more players 130 to participate in the player defined games of gaming system 110 by virtue of the one or more computers 132 participating in secondary games in the multiplayer online gaming system 116. In some implementations, the one or more players 130 can be used a benchmark for the players 118, 122 and 126. The benchmark player 130 may be a professional or highly regarded/known player that the active players would like to gage their performance against. In some implementations, one or more players in communication with gaming system 110 may cause one or more players 130 to participate in player defined games on gaming system 110 without the one or more players 130 knowing of the participation. While online game system 116 is described herein as a system for multiplayer games, it should be appreciated that the systems described herein can be used with single player games. For example, online game system 116 can be substituted for an online game system that provides single player games. For example, a single player fishing game can be offered through the online system. As another example, a single player game such as Microsoft™ Flight Simulator™ can be offered through the online game system 116. As yet another example, a single player game such as an online slot machine game can be offered through the online game system 116.

In some implementations, the online game system 116 is accessible by the gaming system 110 through two-way communications. In some implementations, the gaming system 110 may be able to pull data from the online game system 116 through the online game system's Application Programming Interface (API). Alternatively, the gaming system 110 may be able to receive pushed data sent from the online game system 116 to the gaming system 110 through the gaming system's API. While an online game system 116 is shown for reference in FIG. 1, it should be appreciated that in various implementations, the gaming system 110 can be in communication with one or more different secondary game systems like online game system 116. When two or more different secondary game systems are used, player defined games of the gaming system 110 can be based at least partially on events that occurs in one or more secondary games.

In one implementation, the gaming system 110 is functionally controlled by a control unit. The control unit includes at least one specially configured processor and at least one controller configured to operate with at least one memory device and at least one data storage device (collectively referred to herein as “memory device”).

In one implementation, control unit includes at least one specially configured processor or central processing unit (CPU). In one implementation, specially configured processor includes arithmetic logic units and math co-processors also known as floating point units. In one implementation, specially configured processor includes registers for holding instructions or other data, and cache memory for storing data for faster operation thereupon. In one implementation, specially configured processor may be a multi-core processor that includes two or more processors for enhanced performance, more efficient parallel processing, or other advantageous computing functions. In another implementation, specially configured processor may be one or more processing devices such as microprocessor(s) or integrated circuit(s) and may include one or more controllers. It should be appreciated that in some implementations, a general purpose processor could be specially programmed to perform the functions of specially configured processor.

A controller, in one implementation, is a device or a software program that manages or directs the flow of data between two entities. Often, controllers are special purpose circuitry or software that solve a technical communications problem between different technology systems. In one implementation, a controller functions as an interface between two systems while managing the communications between the systems. In another implementation, a controller functions as an interface between a processor and a peripheral device and functions to control the peripheral device.

In FIG. 1, at least one specially configured processor and controller (collectively referred to herein as “processor”) 112 is configured to communicate with at least one memory device 114. In one implementation, memory device 114 includes one or more memory structures for storing instructions and various types of data. Memory structures may include one or more random access memory units (RAMs) units, one or more read only memory units (ROMs), one or more flash memory units including solid state drives (SSDs), one or more electrically erasable/programmable read only memory units (EEPROMs), etc. Memory structures may include any combination of the forgoing type of memory.

It should be appreciated that in one implementation, communication with a memory device by a processor encompasses the processor accessing the memory device, exchanging data with the memory device, or storing data to the memory device.

Memory device 114 may store all program code and operation data necessary for the operation of the gaming system 110 described hereinbelow. In another implementation, code and operation data necessary for the operation of the gaming system 110 may be stored in a distributed manner such that some code is stored in the memory device 114 and other code is stored remotely from system 110. In one implementation, the code and operation data necessary for the operation of the system includes, for example, basic input and output function data, instruction fetching data, bus and network communication protocol data, and like data.

In addition to the memory device 114 described above, in another implementation, the code and operation data for the operation of the system described hereinbelow may be stored in removable cartridges or flash drives, a compact disk ROM, a digital versatile disk (DVD) optical storage technology, or suitable other fixed non-transitory storage mediums. In another implementation, part or all of the code and operational data for operation of the system may be stored in a remote memory structure and be downloaded to the memory device 114 via a network connection.

In one implementation, the gaming system 110 may utilize any combination of memory devices such as random access memory devices (RAMs), unalterable memory devices (ROMs), and mass storage devices for securely storing and securely communicating the software components or code that facilitate operation and other functions of the gaming system 110.

The subject matter and functional operations described in relation to FIG. 1 can be embodied in hardware, software, or a combination thereof. Described hardware includes the structures described and their functional or operational equivalents. Described functions may be performed by hardware, digital circuitry, computer software, computer firmware, or functionally equivalent combinations thereof.

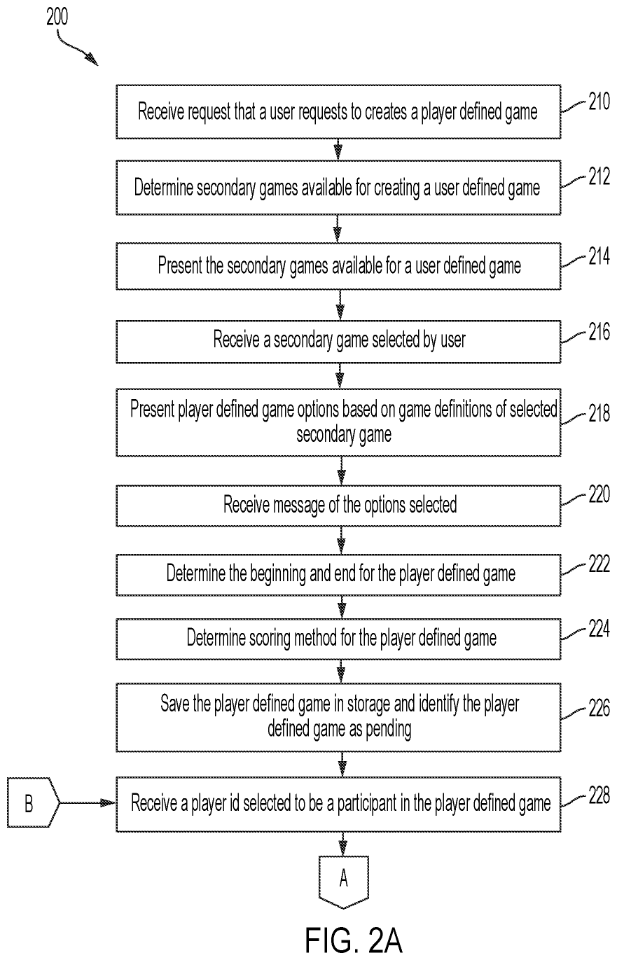

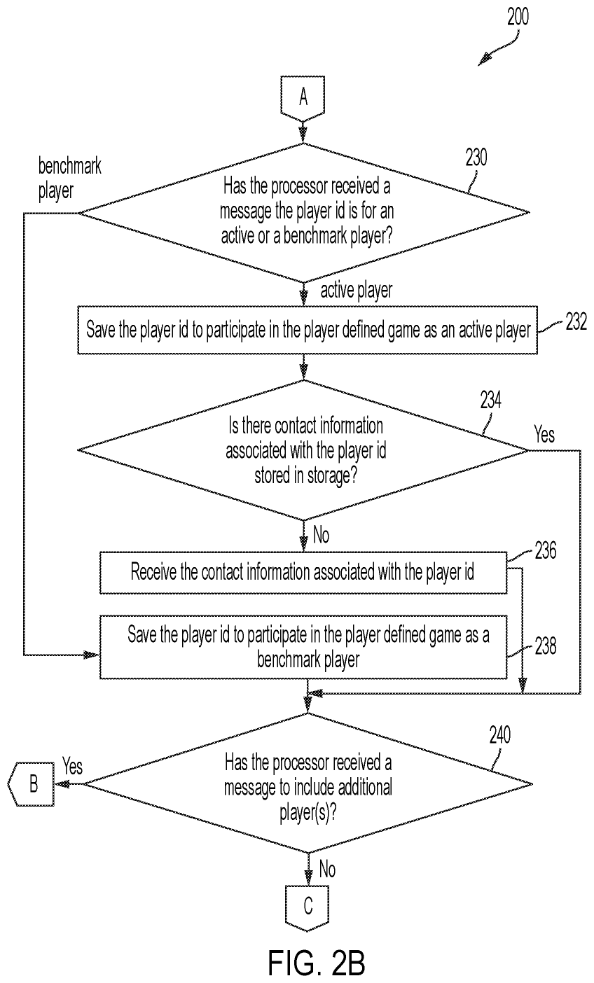

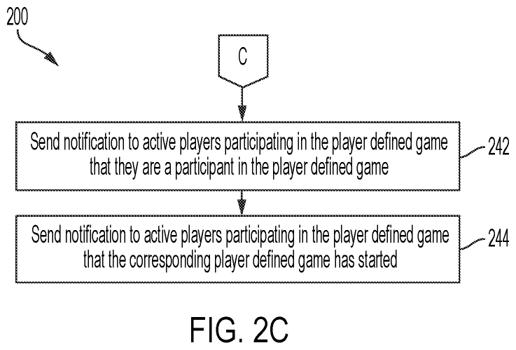

FIGS. 2A, 2B and 2C illustrate a flowchart of an example operation 200 of one implementation of the system and method for setting up a player defined game or player defined challenge. In some implementations, the player defined game works with one or more secondary games to determine the outcome of the player defined game.

In one implementation, a processor 112 of the gaming system 110 (shown in FIG. 1) is configured, via instructions stored in a memory device 114, to perform the operation 200. In some implementations, one or more processors and one or more memory devices may be used to perform operation 200. In some implementations, operation 200 can be distributed and executed using a one or more servers. It should be appreciated that other suitable variations of operation 200 are possible. For example, in one implementation, fewer or one or more additional blocks (not shown) may be employed in operation 200 of the system and method. In other implementations, the blocks may be performed in any suitable order.

As indicated in block 210, the gaming system 110 may receive a request from the computer 120 associated with a user or player 118 (shown in FIG. 1) to create a player defined game on gaming system 110. In some implementations, player defined games can be created simultaneously with other player defined games. In some implementations, player defined games can be created after other player defined games have been created or even started. It should be appreciated, that player defined games can be created at any suitable time and can be created independent of when other player defined games are being created, executed, or completed. In some implementations, the user or player 118 may have a subscription to the gaming services associated with the gaming system 110, that the user requests to create a player defined game on gaming system 110. In some implementations, the user or player 118 does not require a subscription to the gaming services associated with the gaming system 110. In some implementations, it should be appreciated that a user 118, such as a corporate sponsor, may desire to use the gaming system 110 to create one or more player defined games as part of their marketing or promotional services.

In one implementation, the gaming system 110 determines the secondary games that are available for creating a user defined game as indicated in block 212. After the gaming system 110 presents the secondary games available for use with a user defined game, in accordance to block 214; the gaming system 110 may receive a message from the computer of the user, as indicated in block 216, of the secondary game selected by the user. In some implementations, the gaming system 110 includes one secondary game that can be used with the player defined game. For example, the gaming system 110 enables the player to create a player defined game using a secondary game such as, but not limited to, League of Legends™. In some implementations, the gaming system 110 includes a plurality of secondary games that can be used with the player defined game. For example, the gaming system 110 enables the player to create a player defined game using a secondary game selected from a list, such as, but not limited to, League of Legends™, Microsoft™ Flight Simulator™. In some implementations, the gaming system 110 enables the player to select one or more secondary games to use with the user defined game. In example with one or more secondary games for a user defined game, the gaming system 110 may enable the player to select a first secondary game (e.g., League of Legends™) and select a second secondary game (e.g., Forza™) for the one user defined game.

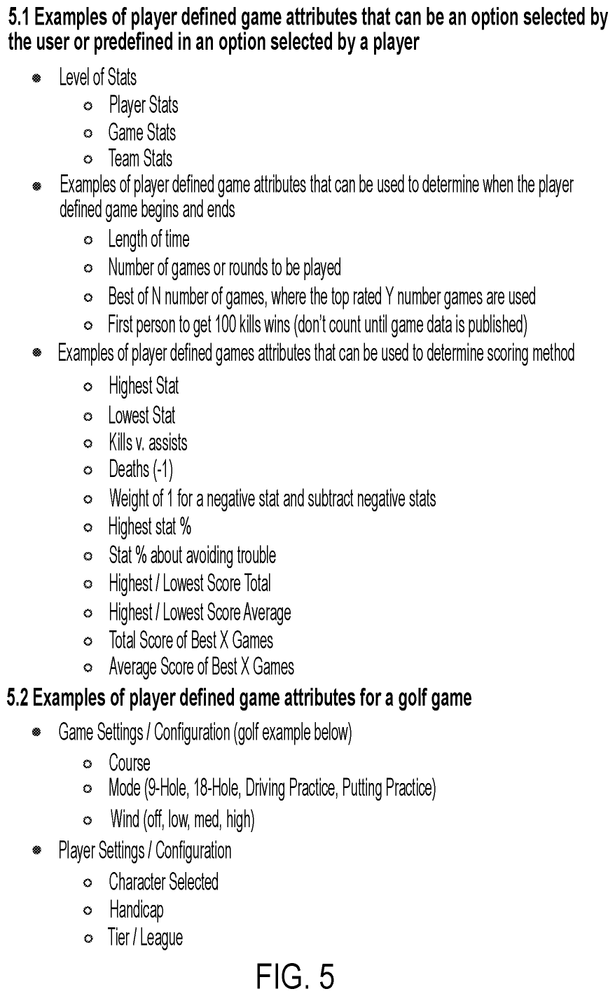

In some implementations, once the system receives the secondary game selected, the system presents to the user one of more player defined game options. In some implementations, player defined game options are based on the game definitions of a selected secondary game in accordance to block 218. In some implementations, the player defined game options are independent of the selected secondary game (e.g., the player defined game will run for 1 week, the player defined game will run until it rains in a predefined city, etc.). A player defined game option selected by the user may be an attribute or a predefined collection of attributes. Some examples of attributes that can be used to define the player defined game are listed in FIG. 5. The attributes can be statistics from the selected secondary game, which can be used in part to determine the results of the player defined game. Examples of the statistics may include, but are not limited to, individual player statistics, game statistics (e.g., how many players participated in a game), and/or team statistics. In some implementations, the attributes can also be used to determine when the player defined game begins and ends. Examples of attributes that can be used to determine when the player defined game begins and ends may include, but are not limited to, a predetermined length of time, the number of games, best of X number of games (counting only the top X number of rated games), number rounds of a game to be played, and/or first person to get 100 kills (e.g., starting a kill count once secondary game data is published). The player selectable attributes can also determine the scoring method. Examples of attributes from the selected secondary game that can be used to determine a scoring method for the player defined game may include, but is not limited to, highest game score statistics, lowest death count statistics, number of kills v. assists, negative counts for death, negative counts for negative in game statistics, and/or statistics for avoiding trouble. The available attributes may vary depending on the secondary games selected. For example, in some implementations, a continuous game like World of Warcraft™ may not have the concepts of rounds because the game is always running. However, in some implementations, an available attribute may include rounds even for a continuous game. As another example, a flight simulator game may cause the gaming system 110 to provide the player with attributes related to activities in the flight simulator game (e.g., ability to land, ability to avoid obstacles, etc.). A fighting game may cause the gaming system 110 to provide the player with attributes related to a fighting game (e.g., how many punches a player can land, how many punches were blocked, etc.). In some implementations, the gaming system 110 may enable a user to define their own game options where the gaming system 110 can determine an outcome or result of the game option (e.g., a way to measure the game option). Section 5.1 of FIG. 5 illustrates some general examples of player defined game options. Section 5.2 of FIG. 5 illustrates some specific examples of player defined game options for a golf game. It should be appreciate that these are general examples and should not be treated as limiting.

In some implementations, the gaming system 110 receives the user selected game options in accordance block 220, the gaming system 110 may determine the beginning and end for the player defined game in accordance to block 222 and may determine the scoring method for the player defined game in accordance to block 224. As noted above, the determinations in block 222 and the determined in block 224 can be based on the user selected game options in some implementations. For example, if one of the user selected game options is “the game starts tomorrow at midnight Eastern Time” and “the game is played until a first player in a selected secondary game obtains a rare weapon,” the gaming system 110 may determine that the player defined games starts at midnight Eastern Time and will continuously run until a player in the secondary game obtains the rare weapon. In accordance with block 226, the gaming system 110 may save the player defined game in storage (e.g., memory device 114 or other suitable storage). In some implementations, the gaming system 110 may also store in memory that the player defined game is set as pending (as opposed to a player defined game that has ended).

In accordance to block 228, the gaming system 110 may receive from the user 118, a player id of one or more players who have been selected to be a participant in the player defined game. The player id may be the user's player id and/or the player id of one or more other players. It should be appreciated that player defined game can be used with a single player or with multiple players. In some implementations, the player creating the player defined game may invite only themselves to the player defined game (or themselves in addition to one or more benchmark players). In some implementations, a person may create a player defined game that the person does not participate in. In some implementations, the person may create a player defined game for a single player that is not themselves. In some implementations, the person may create a player defined game for multiple players that may or may not include themselves.

The process of operation 200 may continue to block 230 via off page connector A in FIG. 2B, in which the system 120 determines whether the processor 112 has received a message that the player id is for an active player or a benchmark player. In some implementations, an active player is a player who will be actively participating in at least one player defined game. In some implementations, an active player is a player who receives and accepts an invitation to participate in the player defined game. In some implementations, an active player may receive updates about the progress of the player defined game. In some implementations, the active player may receive an update regarding the outcome of the player defined game. In some implementations, a benchmark player is a player who is not actively participating in the player defined game. In some implementations, a benchmark player does not receive an invitation and/or does not accept an invitation to participate in the player defined game. In some implementations, a benchmark player may not be aware of the player defined game and does not receive information about the outcome of the player defined game. In some implementations, users of the player defined game may wish to include certain players (e.g., benchmark players) such as famous or skilled players without alerting such players that they will participate in the player defined game. The gaming system 110 may obtain data about how a benchmark player plays in the selected secondary game and uses such secondary game data to evaluate the player defined game, but the benchmark player does not have to accept an invitation to play in the player defined game and the benchmark player may not even be aware that they are inactively participating in the player defined game. By enabling the gaming system 110 to include benchmark players in a player defined game, the gaming system 110 allows active players to gage their performance in the player defined game against such benchmark players. As noted above, in some implementations, a person can create a player defined game where the participants are one active player and one or more benchmark players.

If the processor receives a message that the player id is for an active player, the gaming system 110 saves the player id to participate in the player defined game as an active player in accordance to block 232. The gaming system 110 may determine if there is contact information associated with the player id already stored in its memory device 114 in accordance to block 234. In some implementations, if there is no contact information associated with the player id already stored in the system's memory device 114, the process of operation 200 continues to block 236 in which the gaming system 110 receives, from the user's input device, a contact information associated with the player id and stores the contact information in its memory device 114. The process of operation 200 then continues to block 240 to determine if the processor 112 has received a message to include additional player(s). It should be appreciated that while operation 200 shows inputting players one at a time, in some implementations, the gaming system 110 may enable the user creating the player defined game to input multiple players at the same or substantially the same time. Referring back to block 234, if there is already contact information associated with player id stored in the system's memory device 114, the process of operation 200 may continue to block 240 to determine if the processor 112 has received a message to include additional player(s).

Referring back to block 230, in some implementations, if the processor receives a message that the player id is for a benchmark player, the gaming system 110 saves the player id to participate in the player defined game as a benchmark player in accordance to block 238. In some implementations, the process of operation 200 continues to block 240 to determine if the processor 112 has received a message to include additional player(s).

In some implementations, if the processor received a message to include additional player(s), the process of operation 200 may return to block 228 to receive a player id selected to be a participant in the player defined game via off page connector B. If the processor did not receive a message to include additional player(s), the process of operation 200 may continue to block 242 via off page connector C in FIG. 2C in which the gaming system 110 sends a notification to the active players that they are participating in the player defined game. In some implementations, the active players are automatically included as active players in the player defined game. In some implementations, the gaming system 110 enables the players to accept the opportunity to actively participate in the player defined game. In some implementations, if the player declines to participate in the player defined game, the gaming system 110 may convert the declining player to a benchmark player. In some implementations, the gaming system 110 if the player declines to participate in the player defined game, the gaming system 110 may enable the user that created the player defined game to remove the player from participating in the player defined game. In some implementations, once the player defined game has started, in accordance to block 244, the gaming system 110 may send a notification to the active players participating in the player defined game to notify the players that the player defined game has started.

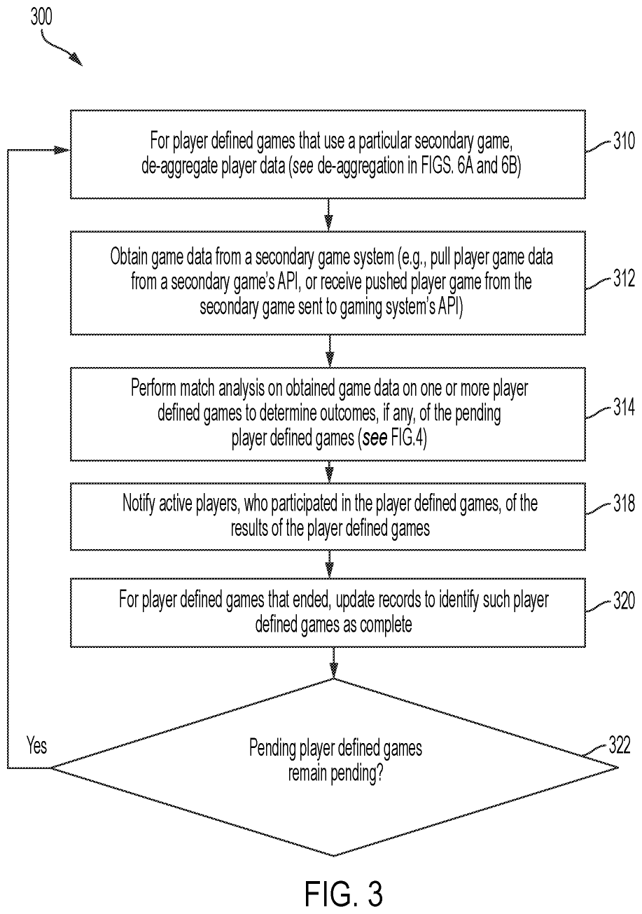

FIG. 3 illustrates a flowchart of an example operation 300 of one implementation of the system and method for enhancing communications with secondary game systems and enhancing the evaluation of player defined games. As will be described herein, the enhancements may include efficient data communications using de-aggregated data in pending player defined games and reaggregating the data obtained from secondary game systems for evaluating player defined game outcomes.

In some implementations, the gaming system 110 uses at least a portion of game data from secondary game system in the evaluation of outcomes for player defined games run on the gaming system 110. For example, in a player defined game that is based on a tennis game, a player may have defined the player defined game as a challenge or competition among two or more players (e.g., active and/or benchmark players). The gaming system 110 may evaluate the challenge based on player selected game options such as the player that made (e.g., properly completed) the most first serves and the player that won the most games, over a 1-week period. The gaming system 110 may evaluate the ultimate winner as the player that won the most games and made the most first serves, but weighted the player with the most first serves greater than simply winning the most games. Thus, the gaming system 110 may determine a player from among two or more players as a winner when a player made the most first serves and was a higher ranking player in terms winning the most tennis games. In some implementations, gaming system 110 may use game data from one or more tennis games played on one or more secondary game systems. Players may play the tennis game on a secondary game system. As players play the tennis game on the secondary game system, the secondary game system may track events and outcomes during the tennis games. For example, the secondary game system may track how many first serves players made during games. The secondary game system may track how many games, sets, matches the players won or lost during a predetermined time period. The gaming system 110 may periodically query (e.g., once a day, once an hour, or some other suitable time period, etc.) the secondary game system for stored or live data related to the tennis games, such as how many first serves players made and how many games, sets, and matches the players won or lost for the predetermined time period. The gaming system 110 may use this data alone or in combination with other collected game data to evaluate the winner for the player defined game or challenge.

In relying on secondary game systems for data, especially when the gaming system 110 evaluates numerous pending player defined games (e.g., thousands or more games), the gaming system 110 may transmit data requests to the secondary game systems, which can be extremely resource intensive for both the gaming system 110 and the secondary game systems. Secondary game systems may address the physical resource usage by limiting the amount and frequency of data that can be obtained from the secondary game systems. Operators of the secondary game systems may also charge higher or additional fees for data requests that exceed a predetermined threshold. To address this issue, gaming system 110 can be configured to efficiently use processing resources, memory, and minimize data communication traffic to reduce the physical resource burdens on the gaming system 110 itself as well as secondary game servers. Some implementations of these improvements are described herein below.

Returning to FIG. 3, in some implementations, a processor 112 of the gaming system 110 (shown in FIG. 1) is configured, via instructions stored in a memory device 114, to perform the operation 300. However, it should be appreciated that other suitable variations of operation 300 are possible. For example, in one implementation, fewer or one or more additional blocks (not shown) may be employed in operation 300 of the system and method. In other implementations, the blocks may be performed in any suitable order.

After the gaming system 110 has set up a player defined game or a number of player defined games in accordance to an operation such as example operation 200 discussed in connection with FIGS. 2A-2C, the gaming system 110 may obtain game data from one or more secondary game systems to evaluate the player defined games. As can be appreciated, the gaming system 110 may have one or more player defined games running at a time. For example, gaming system 110 could have hundreds, thousands or even millions of player defined games that require execution, data, and outcome evaluations. To avoid physically taxing the gaming system 110, a secondary game system, and/or the communication network between the gaming system 110 and the secondary game system, in some implementations, the gaming system 110 may be configured to de-aggregate data from pending player defined games to reduce data communicated to the secondary game system and to reduce the data obtained from the secondary game system. In some implementations, the de-aggregation of data can be viewed as obtaining minimally sufficient player data to obtain relevant data from the secondary game system.

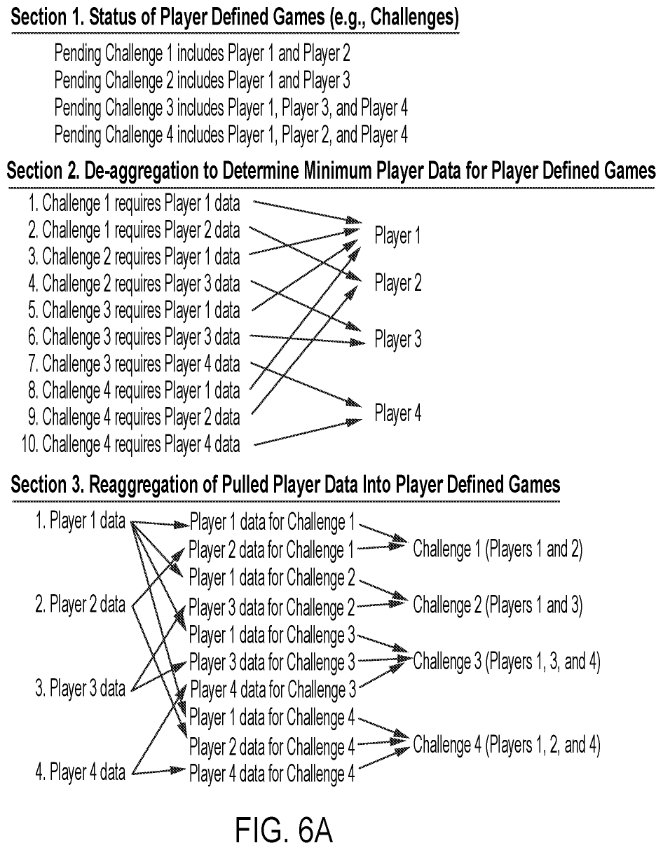

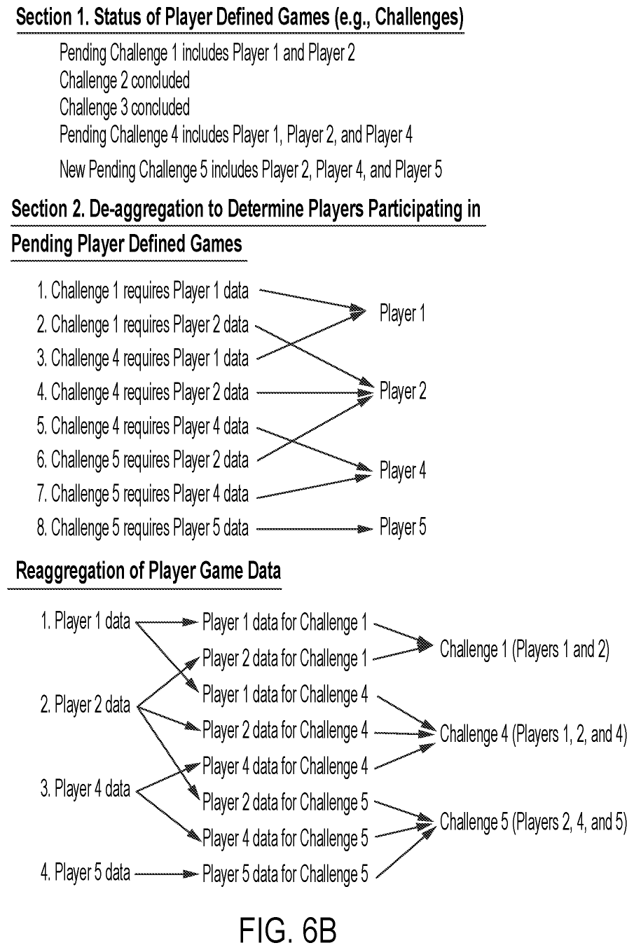

FIG. 6A, Section 1 illustrates the gaming system 110 running four player defined games (e.g., Challenge 1, Challenge 2, Challenge 3, and Challenge 4). In some implementations, the player defined games are associated with one or more secondary games hosted on one or more secondary game servers. For example, in some implementations, one or more of the player defined games are associated with a same secondary game (e.g., Challenge 1-Challenge 4 can be associated with League of Legends™). In some implementations, one or more of the player defined games are associated with a different secondary games (e.g., Challenge 1 can be associated with League of Legends™, Challenge 2 can be associated with a tennis game, Challenge 3 can be associated with League of Legends™ and Microsoft™ Flight Simulator™, and Challenge 4 can be associated with a tennis game and Mario Kart 8 Deluxe™). It should be appreciated that any suitable secondary games and combinations thereof can be used. These four player defined games can include different combinations of players. To evaluate the player defined games, the gaming system 110 obtains player data for the listed players. In some implementations, the gaming system 110 may seek to obtain player data on a Challenge by Challenge basis. For example, the gaming system 110 may determine that Challenge 1 includes Player 1 and Player 2. The gaming system 110 may send a data request to a secondary game server for data related to Player 1 and record that data in gaming system 110. The gaming system 110 may also send a data request to a secondary game server for data related to Player 2 and record that data in gaming system 110. In some implementations, the gaming system 110 may combine the data requests for Player 1 and Player 2 for Challenge 1. The gaming system 110 may make similar data requests for the other pending Challenges. As can be seen in FIG. 6A, Section 2, the four Challenges can quickly increase the amount of data and data requests that would be sent between the gaming system 110 and the secondary game server. Obtaining the game data in this manner would increase the amount of processing and memory usage on both the gaming system 110 and the secondary game server as well as increase the data that was transmitted on the network between the gaming system 110 and the secondary game server.

In contrast, FIG. 3 illustrates some implementations of a more efficient process to communicate game data such that the amount of processing and memory usage on both the gaming system 110 and the secondary game server are greatly reduced, as well as greatly reducing the data that was transmitted on the network between the gaming system 110 and the secondary game server. It should be appreciated that when implementations of FIG. 3 are used to process hundreds, thousands, or millions of player defined games, the gains from the increased efficiency become much more pronounced.

Returning to FIG. 3, as indicated in block 310, the gaming system 110 may de-aggregate the pending player defined games to determine which players are participating in the pending player defined games. The process of de-aggregating the pending player defined games are illustrated in FIGS. 6A and 6B, providing examples at two different time periods. FIG. 6A illustrates an example set up of player defined games in which one or more users have set up Challenges 1, 2, 3 and 4. The four player defined games are associated with the status of currently pending with Challenge 1 to include players 1 and 2 as participants, Challenge 2 to include players 1 and 3 as participants, Challenge 3 to include players 1, 3 and 4 as participants, and Challenge 4 to include players 1, 2 and 4 as participants. It should be appreciated that the player could be active participants or benchmark participants. The de-aggregating process under the chart titled “De-aggregation to Determine Minimum Player Data for Player Defined Games” in FIG. 6A identifies the player data needed for player defined games as shown in the left column. For this example set up of player defined games in FIG. 6A, the gaming system 110 may use ten data sets for the players to evaluate outcomes in the four player defined games. For example, to evaluate Challenge 1, the gaming system 110 may need player 1 data and player 2 data. In some implementations, rather than pulling the data on a per Challenge and per player basis as discussed above, the de-aggregation process determines which players are in the pending player defined games and creates a list of individual players for a particular secondary game. For the example in FIG. 6A of player defined games, the gaming system 110 determined that player 1, player 2, player 3, and player 4 are in the pending player defined games and that the gaming system 110 can obtain the data for player 1, player 2, player 3, and player 4 for the pending player defined games, rather than requesting the data for players 1-4 multiple times from the secondary game server.

It should be appreciated that the de-aggregating process may look different depending on the secondary games used in the player defined games and whether the secondary games are hosted at one or more different secondary game servers. For example, if a same secondary game is used among the Challenges listed in FIG. 6A, then the de-aggregation may reduce the player data to be captured (e.g., player 1 's data may be the same in this instance across multiple player defined games) as shown in Section 2 of FIG. 6A. In some implementations where the secondary games used in the player defined games are different, the resulting de-aggregation may involve a larger data set. For example, if Challenge 1 and Challenge 2 include different secondary games on different secondary servers, then the de-aggregation may include player 1 associated with a first secondary game and player 2 associated with a second secondary game, rather than the one player 1 shown in Section 2 of FIG. 6A.

FIG. 6B illustrates another example set of player defined games at a different time period in which Challenge 2 and Challenge 3 have concluded and a new Challenge 5 has been added by a user. For the player defined games in FIG. 6B, Challenges 1, 4 and 5 are pending with Challenge 1 to include players 1 and 2 as participants, Challenge 4 to include players 1, 2 and 4 as participants, and Challenge 5 to include players 2, 4 and 5 as participants. The de-aggregating process under the chart titled “De-aggregation to Determine Minimum Player Data for Player Defined Games” in FIG. 6B identifies the player data needed for player defined game as shown in the left column. For this example set up of player defined games in FIG. 6B, the gaming system 110 may use eight data sets for the players to evaluate outcomes in the three player defined games. In some implementations, rather than obtaining player data on a per Challenge and per player basis as discussed above, the de-aggregation process may determine which players are in the pending player defined games and obtain the data for those players for a particular secondary game. For this example in FIG. 6B set up of player defined games, the gaming system 110 determined that player 1, player 2, player 4 and player 5 are in the pending player defined games and that the gaming system 110 can obtain the data for player 1, player 2, player 4 and player 5 for the pending player defined games, rather than requesting the data for players 1, 2, 4, and 5 multiple times from the secondary game server.

Referring back to FIG. 3, in some implementations, once the system has determined the minimum player data from the pending player defined games to request from a secondary game server through the de-aggregation process in block 310, game data for the players may be obtained from a secondary game system (e.g., multiplayer online gaming system 116) through the secondary game system's API in accordance to block 312. For example, the gaming system 110 may transmit unique player information associated with the identified players to the secondary server and request game data for such identified players. In some implementations, the request to the secondary game server may include a request for some or all game data for the identified players. In some implementations, the request to the secondary game server may enable the gaming system 110 to request specific player game data to further reduce data that must be collected by the secondary game server and transmitted from the secondary game to the gaming system 110. Alternatively, in some implementations, the game data for the participating players may be pushed from the secondary game system (e.g., multiplayer online gaming system 116) to an API for the gaming system 110 in accordance to block 312. In some implementations, where player game data is pushed from a secondary game system, the gaming system 110 may need to periodically update the secondary game system with a list of players and player data requested so that the secondary game system knows which player game data to push to the gaming system 110.

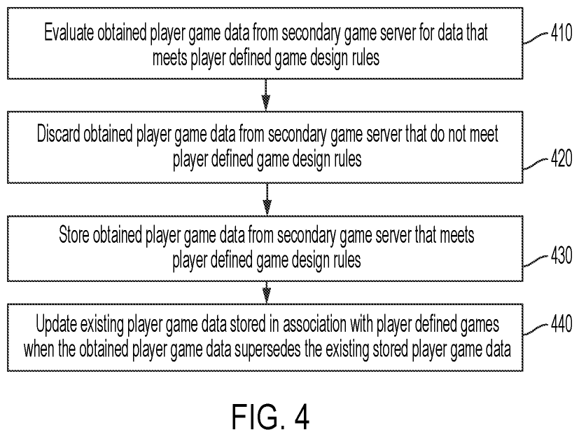

In some implementations, as illustrated in block 314, the gaming system 110 may perform match analysis on obtained game data for one or more player defined games (e.g., the Challenges in FIG. 6A or FIG. 6B). In some implementations, the match analysis may include reaggregation of the game data obtained from the secondary system. In some implementations, the match analysis may include determining outcomes of the player defined games. In some implementations, the outcomes may include winners of the player defined games. For example, if a player defined game defined a winner as the player to capture the most of a particular creature in a secondary game played on a secondary game system, the gaming system 110 may evaluate the obtained game data to determine if one of the players participating in the player defined game obtained more of the particular creature than the other player in the player defined game. In some implementations, when the player defined games are not complete (e.g., additional secondary games remain to be played to feed more game data into the player defined games), the gaming system 110 may update current player standings for pending player defined games. Additional details of the match analyzer are discussed below in connection with FIG. 4.

In some implementations, as shown in block 318, the gaming system 110 may notify active players in the player defined games, the results of the player defined games. As noted above, this may include interim results of player defined games. This may also include completed results of player defined games. In some implementations, as shown in block 320, the gaming system 110 may update its records to identify player defined games that are complete as ended (e.g., not pending).

In some implementations, as shown in block 322, the gaming system 110 may evaluate whether player defined games remain pending. If there are player defined games that are not completed, the gaming system 110 may return to block 310 to obtain new data for pending player defined games. In some implementations, restarting block 310 may be based on a period schedule (e.g., once an hour, once a day, or some other suitable time interval). In some implementations, if the gaming system 110 determines that no pending player defined games remain, the process may end. In some implementations, the operation 300 may restart at a suitable periodic schedule or upon creation of a new player defined game.

FIG. 4 illustrates a flowchart of an example operation 400 of one implementation of the system and method for determining results for pending player defined games. In some implementations, operation 400 is part of the match analysis discussed in connection with block 314 of FIG. 3.

In one implementation, a processor 112 of the gaming system 110 (shown in FIG. 1) is configured, via instructions stored in a memory device 114, to perform the operation 400. However, it should be appreciated that other suitable variations of operation 400 are possible. For example, in one implementation, fewer or one or more additional blocks (not shown) may be employed in operation 400 of the system and method. In other implementations, the blocks may be performed in any suitable order.

As noted in FIG. 3, in some implementations, the match analysis process may include an advanced screening and reaggregation process for game data obtained from a secondary server. As illustrated in block 410, in some implementations, the gaming system 110 may evaluate obtained player game data from the secondary game server. The evaluation may include determining whether one or more data records meet player defined game design rules (e.g., game options selected when creating a player defined game). The evaluation may examine whether particular data records match with options used to create the player defined game. Returning to the tennis example, the secondary game server may have captured game data on how many service faults a player committed during the relevant player defined game period. The secondary game server may send that tennis service fault data to the gaming system 110. If gaming system 110 determines that the player defined games that player participates in does not use the tennis service fault data for a player to determine an outcome, the gaming system 110 may delete the tennis fault data on the player from memory, as shown in block 420. As another example, in a golf game, a secondary game server may have sent the gaming system 110 golf game data for multiple golf courses (e.g., a first golf course and a second golf course) for a player because the player played on both golf courses and generate game data for both courses. In some implementations, if a player defined game uses golf game data from the first golf course, but not the second golf course, the gaming system 110 may discard or delete from memory one or more portions of data for the second golf course.

As shown in block 430, in some implementations, where obtained game data does meet with defined game design rules, the gaming system 110 may reaggregate and store the obtained game data. In some implementations, the gaming system 110 may store one copy of the obtained player game data that can be referenced during one or more Challenge evaluations (e.g., FIG. 6A, Section 3). For example, a reference to the stored player game data can be stored in association with the Challenges that need the specific player data for evaluating the outcome of a player defined game. In some implementations, the gaming system 110 may store multiple copies of the obtained player game data that can referenced during one of more Challenge evaluations. For example, in some implementations, the gaming system 110 may duplicate and store, as necessary, the obtained player game data in association with one or more Challenges for the pending player defined games. Some examples of the process of reaggregating the obtained player game data is illustrated in Section 3 of FIGS. 6A and 6B, showing examples of reaggregation at two different time periods.

FIG. 6A, Section 3 illustrates an example implementation in which obtained player data from a secondary game server is reaggregated to player defined games (e.g., Challenge 1, Challenge 2, Challenge 3, and Challenge 4). Using the reaggregation process, in some implementations, the gaming system 110 may update and save player 1 data for Challenge 1 with the obtained player 1 game data, update and save player 1 game data for Challenge 2 with the obtained player 1 game data, update and save player 1 game data for Challenge 3 with the obtained player 1 game data, and update and save player 1 game data for Challenge 4 with the obtained player 1 game data. As noted above, the gaming system 110 may make duplicates of the player 1 game data or create one or more references to the stored player 1 game data for the pending Challenges. The gaming system 110 may perform a similar updates and data saves to the other obtained player game data for the pending Challenges (e.g., updating the Challenge 1 and Challenge 4 with the obtained player 2 game data, etc.).

FIG. 6B illustrates another example implementation in which obtained player data is reaggregated to player defined games (e.g., Challenge 1, Challenge 4, and Challenge 5). Using the reaggregation process, in some implementations, the gaming system 110, may update and save player 1 data for Challenge 1 with the obtained player 1 game data, update and save player 1 game data for Challenge 4 with the obtained player 1 game data. The gaming system 110 may update and save player 2 game data for Challenge 1 with the obtained player 2 game data, update and save player 2 game data for Challenge 4 with the obtained player 2 game data, and update and save player 2 game data for Challenge 5 with the obtained player 2 game data. As noted above, the gaming system 110 may make duplicates of the player 1 and player 2 game data or create one or more references to the stored player 1 and player 2 game data for the pending Challenges. The gaming system 110 may perform a similar update and data saves to the other obtained player game data for the pending Challenges (e.g., updating the Challenge 4 and Challenge 5 with the obtained player 4 and player 5 game data, etc.).

Referring back to FIG. 4, the process of operation 400 may continue to block 440. In some implementations, the gaming system 110 may update player game data stored in association with player defined games. For example, if a player defined game is defined to include data from multiple secondary games played over five days, the gaming system 110 may not have complete or final game data from the secondary game server to evaluate the player defined game on first through the fourth days of the five day period. However, the gaming system 110 may obtain data on the first day for players that put a particular player in a lead position (e.g., player 1 killed five dragons in the day of game play and the player defined game evaluates a winner as the player that obtains the most dragon kills). On day two of the five day period, the gaming system 110 may obtain updated game data for the player defined game that indicates that player 4 obtained 20 dragon kills and this dragon kill tally was 6 more kills than player 1. Thus, on day two, the gaming system 110 may evaluate that player 4 is in the lead for the player defined game. In situations such as this, the gaming system 110 may need to update or replace existing data from prior data reaggregation update cycles from a secondary server. Using the dragon killing example above, the gaming system 110 may update player 1 's dragon kill tally to be 14 kills on day 2 from the 5 kills on day 1. Likewise, the gaming system 110 may update player 4's dragon kill tally to be 20 from the prior tally number stored in association with player 4 for the player defined game. In some implementations, the old game data is overwritten. In some implementations, new game data is not used to overwrite old game data, but the gaming system 110 indicates the new game data as the data to use to evaluate outcomes of the player defined games. In some implementations, upon the completion of operation 400, the gaming system 110 may return to evaluating player defined games, such as discussed in block 318 of FIG. 3.

In light of the foregoing descriptions, it should be appreciated that the de-aggregation and reaggregation of player data in the pending player defined games (or challenges) creates an improved and efficient process to communicate game data such that the amount of processing and memory usage on both the gaming system 110 and the secondary game server are greatly reduced, as well as greatly reducing the data that was transmitted on the network between the gaming system 110 and the secondary game server. It should be appreciated that when implementations of described herein are used to process hundreds of thousands or millions of player defined games, the gains from the increased efficiency become very pronounced.

Implementations described herein may be implemented in hardware, firmware, software, or any combination thereof. Implementations of the disclosure herein may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); hardware memory in handheld computers, PDAs, smart phones, and other portable devices; magnetic disk storage media; optical storage media; USB drives and other flash memory devices; Internet cloud storage, and others. Further, firmware, software, routines, instructions, may be described herein as performing certain actions. However, it should be appreciated that such descriptions are merely for convenience and that such actions in fact result from computing devices, processors, controllers or other devices executing the firmware, software, routines, instructions, etc.

Although method/process operations (e.g., blocks) may be described in a specific order, it should be understood that other housekeeping operations can be performed in between operations, or operations can be adjusted so that they occur at different times or can be distributed in a system which allows the occurrence of the processing operations at various intervals associated with the processing, as long as the processing of the overlay operations are performed in the desired way.

The present disclosure is not to be limited in terms of the particular implementations described in this disclosure, which are intended as illustrations of various aspects. Moreover, the various disclosed implementations can be interchangeably used with each other, unless otherwise noted. Many modifications and variations can be made without departing from its spirit and scope, as will be apparent to those skilled in the art. Functionally equivalent methods and apparatuses within the scope of the disclosure, in addition to those enumerated herein will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular implementations only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” In addition, where features or aspects of the disclosure are described in terms of Markush groups, those skilled in the art will recognize that the disclosure is also thereby described in terms of any individual member or subgroup of members of the Markush group. A number of implementations have been described. Various modifications may be made without departing from the spirit and scope of the disclosure. For example, various forms of the method/process flows shown above may be used, with operations or steps re-ordered, added, or removed. Accordingly, other implementations are within the scope of the following claims.

I claim:

1. A game system comprising:
a memory device, and
a processor, wherein the memory device stores program instructions that, when executed by the processor, cause the processor to:
receive a request to create a player defined game;
receive a selection of a secondary game;
generate one or more configuration options for the player defined game based on the selection of the secondary game;
receive one or more selected configuration options for the player defined game;
receive a unique identifier for a player that will participate in the player defined game;
execute the player defined game;
analyze a plurality of different player defined games, wherein the plurality of different player defined games comprises the player defined game;
determine minimally sufficient player data from the plurality of different player defined games to obtain secondary game data for the plurality of different player defined games;
transmit a request to a remote server for the secondary game data for the plurality of different player defined games based on the minimally sufficient player data;
receive the secondary game data for the plurality of different player defined games from the remote server;
associate a portion of the secondary game data with the player defined game; and
determine an outcome of the player defined game based in part on the portion of secondary game data.

2. The system of claim 1, wherein determining minimally sufficient player data from the plurality of different player defined games to obtain secondary game data for the plurality of different player defined games further comprises: de-aggregation of at least one type of data from plurality of different player defined games.

3. The system of claim 2, wherein the program instructions further cause the processor to:
reaggregate at least a portion of the secondary game data in association with the plurality of the different player defined games; and
store the reaggregated at least a portion of the secondary game data in association with the plurality of the different player defined games.

4. The system of claim 3, wherein at least some of the secondary game data associated with at least one of the plurality of the different player defined games is discarded.

5. The system of claim 3, wherein the program instructions further cause the processor to: delete one or more portions of prior reaggregated data based on the storing of the reaggregated at least a portion of the secondary game data.

6. The system of claim 1, wherein the secondary game data comprises data from one or more secondary games.

7. The system of claim 6, wherein the data from one or more secondary games further comprises different rounds of a same secondary game.

8. The system of claim 6, wherein the data from one or more secondary games comprises at least one round of at least two different secondary games.

9. The system of claim 1, wherein the secondary game is a multiplayer game.

10. The system of claim 1, wherein the secondary game is a single player game.

11. The system of claim 1, wherein the program instructions further cause the processor to: transmit an alert of the outcome to at least the first player of the player defined game.

12. The system of claim 1, wherein the program instructions further cause the processor to: receive a plurality of unique identifiers for different players that will participate in the player defined game, wherein at least one of the plurality of unique identifiers for the different players comprises a unique identifier for associated with a benchmark player, wherein secondary game data associated with the benchmark player is used in determining the outcome of the player defined game and the benchmark player does not accept participation in the player defined game.

13. A method of operating a player defined game system comprising:
receiving, using a processor, a request to create a player defined game;
receiving, using the processor, a selection of a secondary game;
generating, using the processor, one or more configuration options for the player defined game based on the selection of the secondary game;
receiving, using the processor, one or more selected configuration options for the player defined game;
receiving, using the processor, a unique identifier for a player that will participate in the player defined game;
executing, using the processor, the player defined game;
analyzing, using the processor, a plurality of different player defined games, wherein the plurality of different player defined games comprises the player defined game;
determining, using the processor, minimally sufficient player data from the plurality of different player defined games to obtain secondary game data for the plurality of different player defined games;
transmitting, using the processor, a request to a remote server for the secondary game data for the plurality of different player defined games based on the minimally sufficient player data;
receiving, using the processor, the secondary game data for the plurality of different player defined games from the remote server;
associating, using the processor, a portion of the secondary game data with the player defined game; and
determining, using the processor, an outcome of the player defined game based in part on the portion of secondary game data.

14. The method of operating the player defined game system of claim 13, wherein determining the minimally sufficient player data from the plurality of different player defined games to obtain secondary game data for the plurality of different player defined games further comprises: de-aggregation of at least one type of data from plurality of different player defined games.

15. The method of operating the player defined game system of claim 14, further comprising:
reaggregating at least a portion of the secondary game data in association with the plurality of the different player defined games; and
storing the reaggregated at least a portion of the secondary game data in association with the plurality of the different player defined games.

16. The method of operating the player defined game system of claim 13, wherein the secondary game data comprises data from one or more secondary games.

17. The method of operating the player defined game system of claim 16, wherein the secondary game data from the one or more secondary games further comprises different rounds of a same secondary game.

18. The method of operating the player defined game system of claim 16, wherein the secondary game data from the one or more secondary games comprises at least one round of at least two different secondary games.

19. The method of operating the player defined game system of claim 13, wherein the secondary game is a multiplayer game.

20. The method of operating the player defined game system of claim 13, further comprising:
receiving a plurality of unique identifiers for different players that will participate in the player defined game, wherein at least one of the plurality of unique identifiers for the different players comprises a unique identifier for associated with a benchmark player, wherein secondary game data associated with the benchmark player is used in determining the outcome of the player defined game and the benchmark player does not accept participation in the player defined game.
